(19) United States
(12) Patent Application Publication
(10) Pub. No.: US 2026/0299856 A1
(43) Pub. Date: Oct. 1, 2026

(54) INFORMATION PROCESSING APPARATUS, METHOD FOR CONTROLLING INFORMATION PROCESSING APPARATUS, STORAGE MEDIUM, IMAGE FORMING APPARATUS, METHOD FOR CONTROLLING IMAGE FORMING APPARATUS, AND STORAGE MEDIUM

(71) Applicant: CANON KABUSHIKI KAISHA, Tokyo (JP)

(72) Inventor: MASARU ONO, Ibaraki (JP)

(21) Appl. No.: 19/571,272

(22) Filed: Mar. 18, 2026

(30) Foreign Application Priority Data
Mar. 25, 2025 (JP) 2025-049639

(51) Int. Cl. G06F 3/12

(52) U.S. Cl. CPC G06F 3/1273; G06F 3/1205

(57) ABSTRACT

The present disclosure allows an identifier indicating that a print instruction is issued using a print setting expansion application to be included in print log information generated by an information processing apparatus. There is provided a control method of an information processing apparatus that receives a print job from a client terminal. The information processing apparatus includes at least one processor operating to perform the control method. The client terminal includes an Internet Printing Protocol (IPP) class driver and an application program installed based on identification information of the information processing apparatus. The control method includes receiving information regarding the print job from the client terminal, the information including first information indicating that a print instruction is issued using the application program, and adding second information based on the first information to print log information of the print job.

### BACKGROUND

### Field of the Technology

The present disclosure relates to an information processing apparatus, a method for controlling an information processing apparatus, a storage medium, an image forming apparatus, a method for controlling an image forming apparatus, and a storage medium.

### Description of the Related Art

In recent years, there has been widely used a print log function of storing usage such as when, by whom, and how an image forming apparatus is used as print log information mainly under office environments.

Further, the print log function is expected to be utilized for an analysis of a route when information is leaked, cost improvement when the apparatus is used, an analysis of a cause when a failure has occurred, and the like by analyzing this print log information.

The print log function is such a function that a print log is automatically stored from the image forming apparatus to a server when a print job is executed by setting information about the server to which the print log is transmitted, an item to be transmitted as the print log information, and the like to the main body of the image forming apparatus in advance. Further, there are also available systems having a mechanism of directly transmitting information such as print settings from a printer driver specific to a vendor to a server as print log information without transmitting it via the image forming apparatus.

Further, in recent years, there have been devised universal printer drivers (local printer drivers) directly communicable with image forming apparatuses using an industry-standard protocol such as Internet Printing Protocol (IPP). Such a local printer driver can communicate with image forming apparatuses of a plurality of printer vendors. Therefore, using the local printer driver allows a user to transmit a print job to an image forming apparatus even without installing the printer driver specific to the vendor.

The above-described local printer driver is subjected to constraints on items and functions settable as print settings because handling print jobs printed by image forming apparatuses of various vendors. To solve such inconvenience, there has been devised a print setting expansion application configured to provide a print setting screen specific to the vendor, acquire intermediate image data from the local printer driver, and perform, for example, image processing specific to the vendor that is unprocessable by the local printer driver, like Japanese Patent Laid-Open No. 2023-178377.

Using this print setting expansion application allows the user to realize a print setting screen and a print job editing function specific to the vendor that are unrealizable by the local printer driver with usability similar to that of the local printer driver. However, whether each job is instructed using the print setting expansion application cannot be distinguished in a print system using the existing image forming apparatus.

### SUMMARY

According to an aspect of the present disclosure, there is provided a control method of an information processing apparatus that receives a print job from a client terminal. The information processing apparatus includes at least one processor operating to perform the control method. The client terminal includes an Internet Printing Protocol (IPP) class driver and an application program installed based on identification information of the information processing apparatus. The method includes receiving information regarding the print job from the client terminal, the information including first information indicating that a print instruction is issued using the application program, and adding second information based on the first information to print log information of the print job.

Features of various embodiments of the present disclosure will become apparent from the following description of embodiments with reference to the attached drawings. The following description of embodiments is described by way of example.

### BRIEF DESCRIPTION OF THE DRAWINGS

FIG. 1 is a system configuration diagram of a print log collection system according to an embodiment of the present disclosure.

FIGS. 2A to 2C are block diagrams illustrating respective examples of the hardware configurations of modules in a print system.

FIG. 3 is a block diagram illustrating examples of the software configurations of the modules in the print system.

FIG. 4 is a sequence diagram illustrating an example of a series of processing procedures in the print system from when an image forming apparatus receives a print instruction from a user until the image forming apparatus performs printing and generates and transmits a print log according to the present embodiment.

FIGS. 5A to 5C illustrate examples of identification information transmitted from a print setting expansion application to the image forming apparatus.

FIG. 6 is a flowchart from when a print button is pressed until printing is performed and the print log is transmitted.

FIG. 7 illustrates an example of a print log transmitted from the image forming apparatus to a print log server.

FIG. 8 illustrates an example of a remote user interface (UI) screen when print log settings are configured.

FIG. 9 is a sequence diagram illustrating an example of a series of processing procedures in a print system according to an embodiment of the present disclosure.

FIGS. 10A and 10B illustrate examples of user information and device information managed by a print log management application.

FIGS. 11A and 11B illustrate examples of an analysis start screen and an analysis result screen of the print log management application.

### DESCRIPTION OF THE EMBODIMENTS

In the following description, example embodiments will be described in detail with reference to the attached drawings. However, the embodiments that will be described below are not intended to limit the present disclosure defined according to the claims. A plurality of features will be described in the embodiments, but this plurality of features is not entirely necessarily essential to the present disclosure, and the plurality of features may be combined arbitrarily. Further, the same or similar configurations will be identified by the same reference numerals in the attached drawings, and a redundant description will be omitted.

When controlling an image forming apparatus, such as a multifunction peripheral, to process a print job, an information processing apparatus uses a printer driver specific to a vendor that is installed in an operating system (OS) or a local printer driver built in as a standard function of the OS.

Generally, the printer driver specific to the vendor is provided for each image forming apparatus, and is configured to assist this image forming apparatus to fully exhibit its capability.

On the other hand, the local printer driver is often confined to supporting only common functionality so as to have universal applicability that allows the local printer driver to perform printing by a wide variety of image forming apparatuses.

In recent years, there has been devised a print setting expansion application configured to perform, for example, image processing specific to the vendor on intermediate image data acquired from the local printer driver, convert it into print data, transmit the print data to the image forming apparatus via the local printer driver, and print the print data. The print setting expansion application is configured to operate together with the local printer driver, and allow this image forming apparatus to fully exert its functionality based on acquired capability information of the image forming apparatus.

A print setting screen and a print job editing function specific to the vendor can be realized by using this print setting expansion application.

Then, Internet Printing Protocol (IPP) has been known as a communication protocol for transmitting and receiving a print job and required information between an information processing apparatus and an image forming apparatus. According to IPP, the print job is constituted by Page Description Language (PDL) data in a predetermined PDL format and IPP attribute information.

Then, the IPP attribute information is information in which processing performed by an image forming apparatus 102 and setting information of the print job are written. The IPP attribute information includes specification regarding print operations such as job creation (Create-Job) and print execution (Print-Job), and specification regarding job operations such as document transmission (Send-Document) and job cancellation (Cancel-Job). Further, the IPP attribute information may include attributes and values thereof specifying print settings, apparatus settings, an output capability, and the like of the image forming apparatus 102. The image forming apparatus 102 performs print processing by analyzing, for example, setting information of the print job from the IPP attribute information.

### First Embodiment

A first embodiment will be described with respect to examples of the configuration of a print log collection system according to the present embodiment and a series of processing procedures until an image forming apparatus generates and transmits print log information to a print log server after performing print processing in this print log collection system. Assume that the "print log information" may be referred to as simply a "print log".

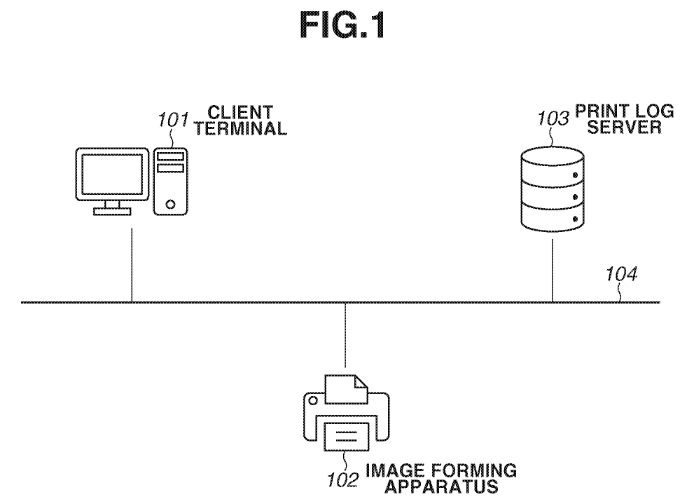

FIG. 1 illustrates a system configuration diagram of the print log collection system according to the present embodiment. The print log collection system according to the present embodiment includes a client terminal 101, the image forming apparatus 102, a print log server 103, and a network 104. The client terminal 101, the image forming apparatus 102, and the print log server 103 are connected via the network 104. FIG. 1 illustrates one apparatus as each of the client terminal 101, the image forming apparatus 102, and the print log server 103, but the print log collection system may include a plurality of client terminals 101, a plurality of image forming apparatuses 102, and/or a plurality of print log servers 103.

The client terminal 101 is an information processing apparatus such as a personal computer (PC) or a smart-phone.

The image forming apparatus 102 is a device that actually performs printing on a recording medium such as paper, and can convert print data received via the network 104 into image data and print the image data.

The print log server 103 can receive the print log information transmitted from the image forming apparatus 102, and store the received information into a storage area. In each communication procedure, control is performed via Hypertext Transfer Protocol (HTTP), Extensible Messaging and Presence Protocol (XMPP), or the like. Another protocol may be used as a communication protocol.

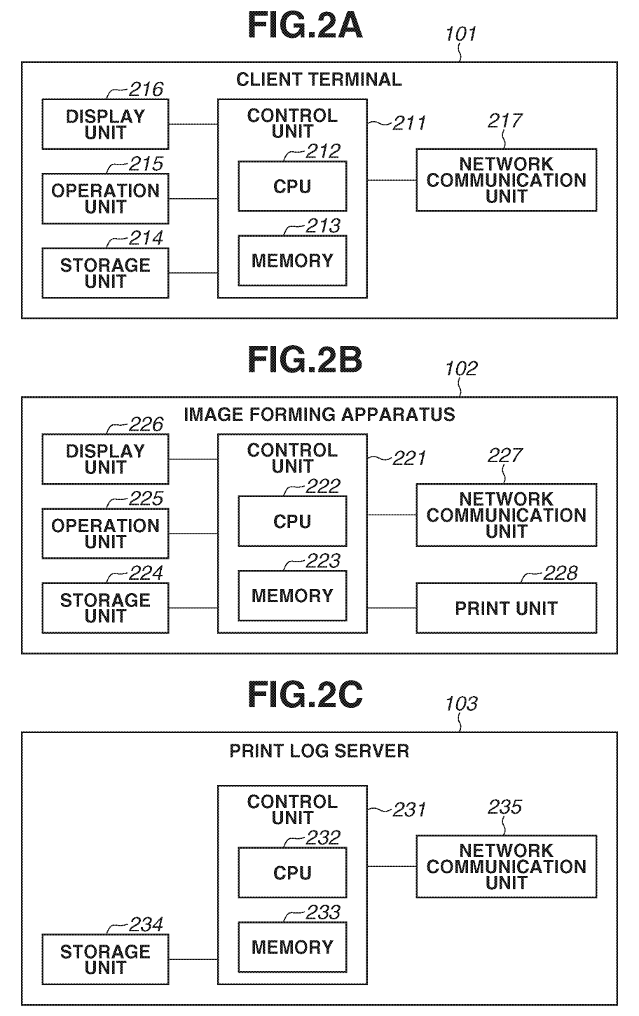

FIGS. 2A to 2C are block diagrams illustrating respective examples of the hardware configurations of modules in a print system 1.

FIG. 2A is a block diagram illustrating the hardware configuration of the client terminal 101.

The client terminal 101 includes a control unit 211, a storage unit 214, an operation unit 215, a display unit 216, and a network communication unit 217.

The control unit 211 includes a central processing unit (CPU) 212 and a memory 213, and controls the overall operation of the client terminal 101. The CPU 212 loads a program stored in the storage unit 214 into the memory 213, and executes it. The memory 213 is a main storage memory of the CPU 212 and is used as a work area or a temporary storage area for loading various kinds of programs.

The storage unit 214 refers to a nonvolatile storage device such as a hard disk or a solid state drive (SSD), and allows digital data to be stored and written therein.

The network communication unit 217 is a device that communicates with the external network 104, and inputs and outputs digital data from and to an external server, an external client terminal, or the like via the network 104.

The display unit 216 is a device for displaying visual information to a user in real time, such as a liquid crystal display. The operation unit 215 is a device for receiving an input from the user using a keyboard, a mouse, or the like. A device having both the functions of the display unit 216 and the operation unit 215, such as a touch panel, may be used.

FIG. 2B is a block diagram illustrating the hardware configuration of the image forming apparatus 102. The image forming apparatus 102 includes a control unit 221, a storage unit 224, an operation unit 225, a display unit 226, a network communication unit 227, and a print unit 228.

The control unit 221 and the storage unit 224 are similar to those of the client terminal 101, and therefore the descriptions thereof will be omitted here.

The operation unit 225 is a device for receiving an input from a user, and may include hardware keys such as a numeric keypad in addition to a touch panel.

The display unit 226 is a device for displaying information to the user in real time, such as a touch panel and a light emitting diode (LED) built in the image forming apparatus 102.

The network communication unit 227 is a device that communicates with the external network 104, and mainly serves to, for example, receive print data and transmit the status of the image forming apparatus 102 such as an error to an external server or the like.

The print unit 228 is a device that executes the print processing by performing a series of operations including paper feeding, printing, and paper discharge on paper prepared in a cassette or a tray. The printing method is not limited to any specific method such as the electrophotographic method or the inkjet method. A two-sided print unit and finishing devices such as a stapler and a punch device used when the paper is discharged are also included in the print unit 228.

The present embodiment will be described assuming that the image forming apparatus 102 is a single-function printer that fulfills only the print function by way of example, but may use a multifunction printer (a multifunction peripheral) that also has a scanner function and a facsimile (FAX) function along therewith.

FIG. 2C is a block diagram illustrating the hardware configuration of the print log server 103. The print log server 103 includes a control unit 231, a storage unit 234, and a network communication unit 235. The control unit 231, the storage unit 234, and the network communication unit 235 are similar to those of the client terminal 101, respectively, and therefore the descriptions thereof will be omitted here.

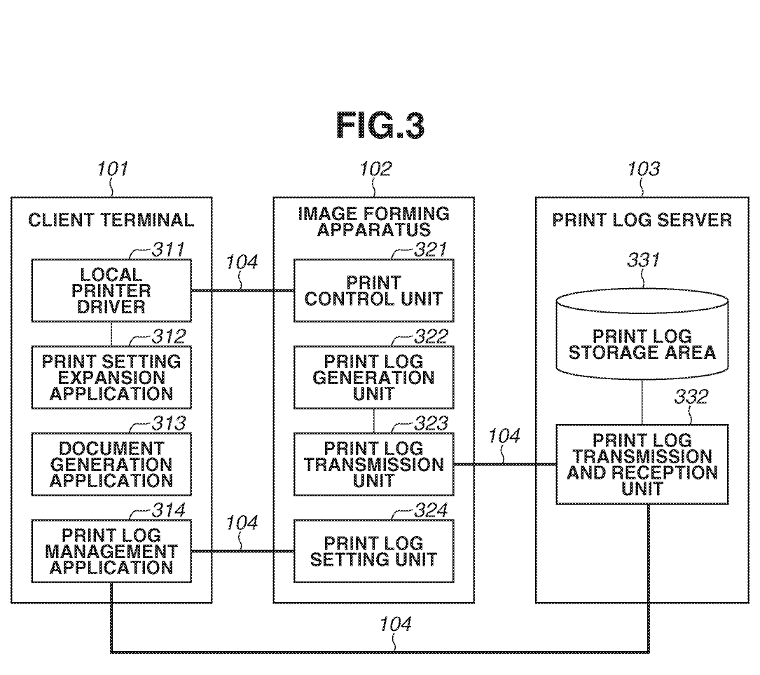

FIG. 3 is a block diagram illustrating examples of the software configurations of the modules in the print system 1.

The client terminal 101 includes a local printer driver 311, a print setting expansion application 312, a document generation application 313, and a print log management application 314.

The local printer driver 311 is a printer driver built in the OS as a standard function. The local printer driver 311 often supports only common functionality so as to have universal applicability that allows the local printer driver 311 to perform printing by a wide variety of image forming apparatuses.

Further, as will be used herein, print modules in the OS will be collectively referred to as print software, and the print software is defined to include the local printer driver 311. In the present embodiment, processing that the information processing apparatus is caused to perform according to an instruction from the local printer driver 311 may be performed according to an instruction from the print software or the OS.

The present example will be described referring to a configuration that uses an IPP Class Driver or a Universal Print (UP) Class Driver built in Windows (registered trademark) as the local printer driver 311. Further, the IPP Class Driver may be referred to as an IPP class driver.

The IPP Class Driver and the UP Class Driver are printer drivers that perform print processing according to the specifications of the standard print protocol called IPP, and are bundled in the OS package.

The IPP Class Driver and the UP Class Driver are standard class drivers capable of transmitting print data to a plurality of different image forming apparatuses provided by a plurality of different manufacturers. The IPP Class Driver and the UP Class Driver are standard drivers that perform local printing and cloud printing according to the above-described specifications, respectively.

When the cloud printing is performed using the UP Class Driver, the print data is not directly transmitted to the image forming apparatus, and is transmitted via a service related to the cloud printing and is printed by the image forming apparatus. Further, the IPP Class Driver and the UP Class Driver acquire capability information of the connected image forming apparatus 102, and generate print function information based on this information. The acquisition of the capability information and generation of the print function information allow the IPP Class Driver and the UP Class Driver to provide a print function specific to the vendor that is supported by the image forming apparatus 102.

The print setting expansion application 312 is an application program configured to allow the image forming apparatus 102 to fully exert its functionality based on the capability information acquired from the image forming apparatus 102 in cooperation with the print software including the local printer driver 311. The print setting expansion application 312 is provided from the manufacturing source, the manufacturer, or the vendor of the image forming apparatus 102, and the user uses it by installing it from an application management server.

Alternatively, the print setting expansion application 312 may be automatically installed based on establishment of a connection of the image forming apparatus 102 to the client terminal 101. More specifically, when the image forming apparatus 102 is connected to the client terminal 101, the OS acquires device identification information from the image forming apparatus 102. The OS may download the print setting expansion application 312 corresponding to the acquired device identification information from a server via the Internet, and install it. In other words, the local printer driver 311 and the print setting expansion application 312 are held by the client terminal 101 as separate files.

The document generation application 313 is an application for generating the print data, and is, for example, Word or PowerPoint.

The print log management application 314 is an application for communicating with the print log server 103 via the network 104, and acquiring and analyzing print log information 701. The print log management application 314 is an example of a management application program.

The image forming apparatus 102 includes a print control unit 321, a print log generation unit 322, a print log transmission unit 323, and a print log setting unit 324.

The print control unit 321 executes a print job received from the local printer driver 311 or the like, and prints the print data onto paper by controlling the print unit 228.

The print log generation unit 322 acquires job setting information 703 and driver information 702 at the time of printing, and generates the print log information 701 to be transmitted to the print log server 103.

The print log transmission unit 323 transmits the print log information 701 generated by the print log generation unit 322 to the print log server 103 via the network 104.

The print log setting unit 324 sets information such as the server address of the print log server 103 and an item to be included in the print log information 701, and stores the setting information.

The print log server 103 includes a print log storage area 331 and a print log transmission and reception unit 332.

The print log storage area 331 is a storage area for storing the print log information 701 received by the print log transmission and reception unit 332.

The print log transmission and reception unit 332, for example, receives the print log information 701 from the print log transmission unit 323 of the image forming apparatus 102 via the network 104, and transmits the print log information 701 to the print log management application 314.

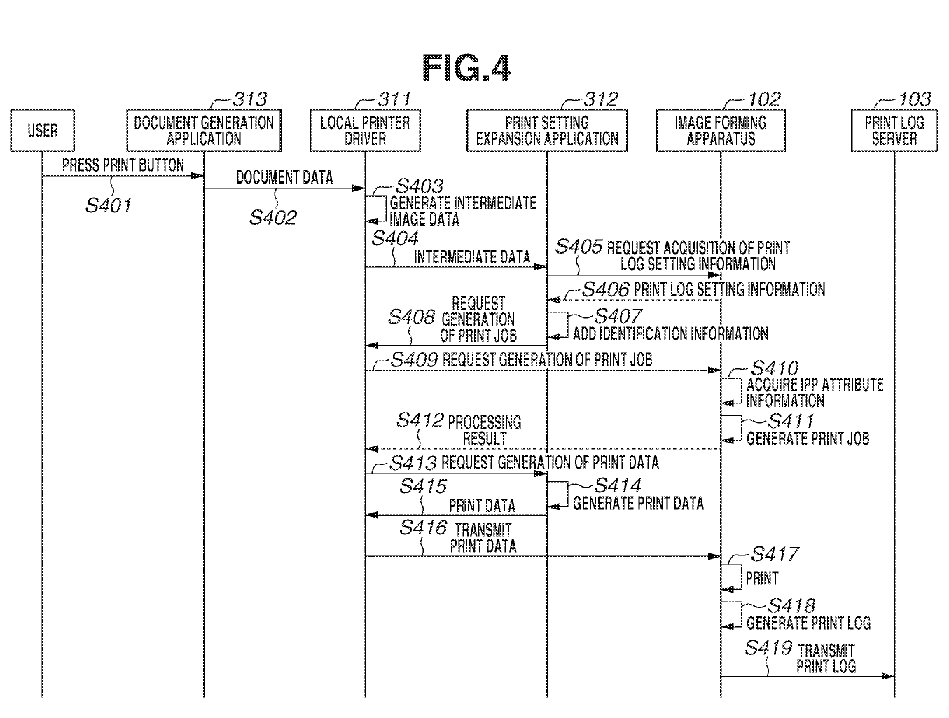

FIG. 4 is a sequence diagram illustrating an example of a series of processing procedures until the image forming apparatus 102 generates and transmits the print log information 701 after receiving a print instruction from the user and performing printing according to the present embodiment.

First, to print a document or the like generated by the document generation application 313, the user selects a printer queue of the image forming apparatus 102 to print the document from a print dialog of this application. A print setting screen of the print setting expansion application 312 is displayed by the user's selecting a property or detailed information of the print dialog. In step S401, print processing is started by, for example, the user's selecting a print button on the print dialog displayed by the document generation application 313 after selecting an OK button on the print setting screen of the print setting expansion application 312.

After the processing of step S401 is performed, in step S402, the document generation application 313 transmits document data corresponding to the generated document or the like to the local printer driver 311.

In step S403, the local printer driver 311 generates intermediate data by converting the document data into data in, for example, an Extensible Markup Language (XML) Paper Specification (XPS) format. In step S404, the local printer driver 311 transfers the generated intermediate data to the print setting expansion application 312.

In step S405, after receiving the intermediate data from the local printer driver 311, the print setting expansion application 312 requests acquisition of print log setting information from the image forming apparatus 102. The print log setting information is information settable by the user via the print log setting unit 324.

In step S406, after receiving the request to acquire the print log setting information, the image forming apparatus 102 transmits the print log setting information to the print setting expansion application 312. The process in step S406 is an example of a log item acquisition process.

After that, in step S407, the print setting expansion application 312 adds identification information, which is a part of the driver information 702, to the IPP attribute information. In step S408, the print setting expansion application 312 requests generation of a print job from the local printer driver 311. The processing of step S407 may be performed based on the print log setting information transmitted from the image forming apparatus 102 in step S406. More specifically, the addition in step S407 may be conducted if the print log setting information transmitted from the image forming apparatus 102 in step S406 includes a setting for adding a driver/application name to a print log. The process in step S407 is an example of a control process.

The driver information 702 is information indicating, for example, the name of a printer driver or an application used for printing. The identification information is, for example, information that makes it possible to distinguish which is used to issue the print instruction, the local printer driver 311 or the print setting expansion application 312.

This will be described more specifically, taking the perspective of an administrator that manages the use of the image forming apparatus 102 in a company or the like by way of example. In this case, it is considered to be more desirable to use the print setting expansion application 312, which is full of functions useful for, for example, a cost reduction and confidentiality management (a toner save function, a copy-forgery-prohibit-pattern function, and the like), than performing printing using the local printer driver 311, which is more functionally restricted. In one conceivable case at this time, the administrator may analyze total numbers, setting information, and the like of jobs transmitted from the local printer driver 311 and jobs transmitted using the print setting expansion application 312 based on the print log information, and manage the usage.

On the other hand, one conceivable case when taking the perspective of a development vendor of the print setting expansion application 312 is that the development vendor may want to analyze the print log information to develop a function of the print setting expansion application 312. In this case, the development vendor of the print setting expansion application 312 is expected to check, for example, a frequently used function of the print setting expansion application 312, a correlation between a device to which a print job is fed and a setting item, and a ratio of jobs for which the print setting expansion application 312 is used among jobs fed to the device. The development vendor of the print setting expansion application 312 and the printer vendor that provides the image forming apparatus 102 are mainly assumed to be the same, but do not have to be the same vendor.

In the above-described case, specific identification information is to be added to the print log and an analysis is to be made based on the identification information to distinguish whether the job is transmitted from the local printer driver 311 or is transmitted using the print setting expansion application 312 based on the print log.

However, conventionally, such identification information has not been added to the print log.

In light thereof, in the present embodiment, the print setting expansion application 312 adds the name of the print setting expansion application 312 as the identification information when the print instruction is issued using the print setting expansion application 312. This identification information is an example of an identifier indicating whether a print instruction is issued using an application program.

When the print instruction is issued using the local printer driver 311, the local printer driver 311 adds the name of the local printer driver 311 as the identification information. On the other hand, when the print instruction is issued using a printer driver provided by the manufacturing source, the manufacturer, or the vendor of the image forming apparatus 102, the name of this printer driver may be added as the identifier to information that this printer driver transmits to the image forming apparatus 102.

In step S407, the print setting expansion application 312 may also add any information such as the version of the application to the IPP attribute information as the driver information 702 besides the identification information.

Referring back to FIG. 4, the present processing will be further described. After that, in step S409, the local printer driver 311 transmits a print job generation request in which the identification information is added to the IPP attribute information to the image forming apparatus 102. The print job generation requests (steps S408 and S409) do not contain the print data and contain only the IPP attribute information.

Further, specifically, "CreateJobOnPrinterWithAttributes" and "Create-Job" operations defined in IPP are assumed to be performed as the print job generation requests (steps S408 and S409), respectively. The print job generation request transmitted from the local printer driver 311 to the image forming apparatus 102 in step S409 is an example of predetermined information transmitted from the information processing apparatus to the image forming apparatus 102.

In step S410, the image forming apparatus 102 acquires the IPP attribute information contained in the print job generation request. In step S411, the image forming apparatus 102 generates a print job. After that, in step S412, the image forming apparatus 102 replies to the local printer driver 311 by transmitting flag information indicating whether the print job is successfully generated, Uniform Resource Identifier (URI) information for feeding the print data to the image forming apparatus 102, and information such as a job ID as a processing result.

After that, the local printer driver 311 confirms that the print job is successfully generated based on the processing result. Then, in step S416, the local printer driver 311 transmits the print data to the image forming apparatus 102. Specifically, a "Send-Document" operation defined in IPP is assumed to be performed as the transmission of the print data (step S416).

As the generation of the print data, the local printer driver 311 may generate the print data based on the intermediate data.

Alternatively, the print setting expansion application 312 may generate the print data based on the intermediate data generated by the local printer driver 311. In this case, in step S413, the local printer driver 311 requests the generation of the data to the print setting expansion application 312. After that, in step S414, the print setting expansion application 312 generates the print data based on the intermediate data. In step S415, the print setting expansion application 312 transmits the generated print data to the local printer driver 311. The print data generated by the print setting expansion application 312 is, for example, data in a Portable Document Format (PDF) or a PDL format of each vendor.

In a case where rendering by the print setting expansion application 312 is unnecessary, the local printer driver 311 may generate the print data based on the intermediate data.

Next, in step S416, the local printer driver 311 transmits the generated print data to the image forming apparatus 102.

In step S417, the image forming apparatus 102 prints the print data received from the local printer driver 311. After that, in step S418, the image forming apparatus 102 generates the print log information 701 by adding the driver information 702 acquired from, for example, the identification information in the IPP attribute information acquired in step S410 to the job setting information 703 at the time of the printing. The job setting information 703 includes information such as the username, the printer name, and the number of printed sheets, and is set by referring to the print setting information of the image forming apparatus 102 or the IPP attribute information.

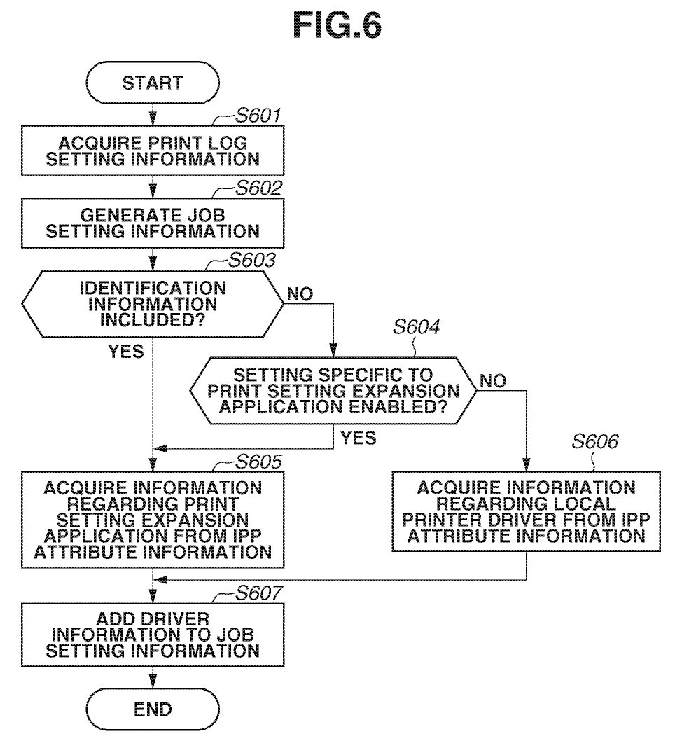

After that, in step S419, the image forming apparatus 102 transmits the print log information 701 to the print log server 103. A detailed operation flow of the print log generation processing (step S418) will be described with reference to FIG. 6.

Regarding the timing of transmitting the print log information 701, the image forming apparatus 102 may be configured to either transmit the print log information 701 each time after performing printing or transmit the print log information 701 for a plurality of jobs all together at once regularly. In the case where the image forming apparatus 102 is configured to transmit the print log information 701 for a plurality of jobs all together at once regularly, the print log information 701 may be stored in the storage unit 224 of the image forming apparatus 102 and transmitted at a timing when a predetermined amount of print log information 701 is accumulated. Alternatively, the print log information 701 may be transmitted at a regular timing such as once a day or once a week. The image forming apparatus 102 may be configured in such a manner that the regular timing is settable by the user.

Alternatively, the image forming apparatus 102 may be configured to transmit the print log information 701 via another information processing apparatus or a server, besides being configured to transmit the print log information 701 directly to the print log server 103.

In a case where the development vendor of the print setting expansion application 312 collects the print log information 701, for example, the development vendor collects the print log information 701 from the print log server 103 and analyzes it.

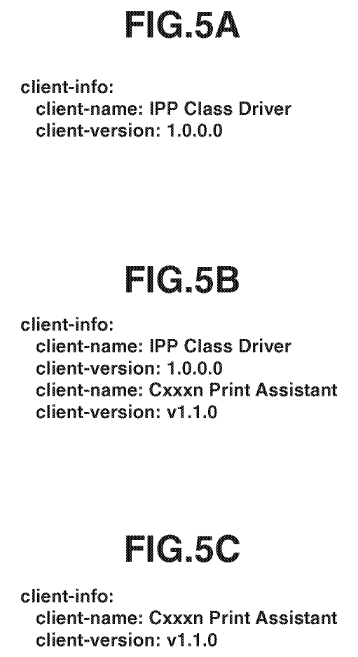

FIGS. 5A to 5C illustrate examples of the driver information 702 including the identification information added as the IPP attribute information. The driver information 702 will be described, citing a "client-info" attribute in the IPP attribute information by way of example here.

FIG. 5A illustrates an example of the IPP attribute information transmitted from the local printer driver 311 when the generation of the print job is requested.

A character string indicating the name of the local printer driver 311 (for example, "IPP Class Driver") is set in the IPP attribute information transmitted from the local printer driver 311 when the generation of the print job is requested. The character string indicating the name of the local printer driver 311 is written in, for example, "client-name" of the "client-info" attribute in this IPP attribute information. Such a character string may not be set depending on the type of the local printer driver 311 in some cases.

FIGS. 5B and 5C illustrate examples of the IPP attribute information transmitted from the print setting expansion application 312 when the generation of the print job is requested.

FIG. 5B illustrates a configuration in which a character string indicating the name of the print setting expansion application 312 is set in "client-name" in addition to the character string indicating the name of the local printer driver 311. In the present example, the character string indicating the name of the local printer driver 311 is, for example, "IPP Class Driver". Further, the character string indicating the name of the print setting expansion application 312 is, for example, "Cxxxn Print Assistant".

FIG. 5C illustrates such a configuration that only the character string indicating the name of the print setting expansion application 312 (for example, "Cxxxn Print Assistant") is included in "client-name".

The IPP attribute information transmitted from the print setting expansion application 312 when the generation of the print job is requested may be transmitted as other attribute information that is not "client-name" without being limited to the examples illustrated in FIGS. 5B and 5C.

FIG. 6 illustrates the operation flow of the print log generation processing (step S418) by the image forming apparatus 102.

First, after the print log generation processing (step S418) is started, in step S601, the image forming apparatus 102 acquires the print log setting information.

The print log setting information is information settable by the user via the print log setting unit 324, and is information in which an item included as the print log information 701 is set. The user can select a print setting added to the print job transmitted to the image forming apparatus 102, such as the name and/or the version information of the local printer driver 311 or the print setting expansion application 312, and the number of sheets and the color setting as the print log setting information. The print log setting information can be set via a remote UI of the image forming apparatus 102, the print log management application 314, or the like. The print log setting information is an example of an item included as the print log information 701.

Next, in step S602, the image forming apparatus 102 extracts the information set in the print log setting information from information such as a job log and a print log at the time of the printing, and generates the job setting information 703. The job log and the print log at the time of the printing are information generated by the image forming apparatus 102 based on, for example, the print settings included in the IPP attribute information transmitted from the information processing apparatus to the image forming apparatus 102 when the generation of the print job is requested.

Next, in step S603, the image forming apparatus 102 determines whether the identification information is included in the IPP attribute information acquired in step S410. More specifically, the image forming apparatus 102 determines whether the character string indicating the name of the print setting expansion application 312 is included in "client-name" of the "client-info" attribute. If the character string indicating the name of the print setting expansion application 312 is included in the IPP attribute information (YES in step S603), in step S605, the image forming apparatus 102 acquires the driver information 702 related to the print setting expansion application 312 such as the version information from the IPP attribute information. After that, in step S607, the image forming apparatus 102 adds the driver information 702 to the job setting information 703, thereby generating the print log information 701.

On the other hand, if the character string indicating the name of the print setting expansion application 312 is not set in "client-name" of the "client-info" attribute (NO in step S603), a setting specific to the print setting expansion application 312 may be enabled in one possible case. In this case, the image forming apparatus 102 determines that the print instruction is issued using the print setting expansion application 312, and proceeds to step S605 to generate the driver information 702 corresponding to the print setting expansion application 312. After that, in step S607, the image forming apparatus 102 generates the print log information 701 by adding the driver information 702 to the job setting information 703.

Now, when the driver information 702 is generated, the driver information 702 is generated by setting a predetermined character string stored in the storage unit 224 of the image forming apparatus 102 as the driver/application name and/or the driver/application version in the driver information 702.

The image forming apparatus 102 may be configured in such a manner that the predetermined character string can be set by the user via, for example, an input field on a print log setting screen 801.

Then, if both the determinations in steps S603 and S604 are NO (NO in steps S603 and S604), in step S606, the image forming apparatus 102 acquires the driver information 702 such as the version information of the local printer driver 311 from the IPP attribute information, determining that the print job is fed from the local printer driver 311. After that, in step S607, the image forming apparatus 102 adds the driver information 702 to the job setting information 703, thereby generating the print log information 701.

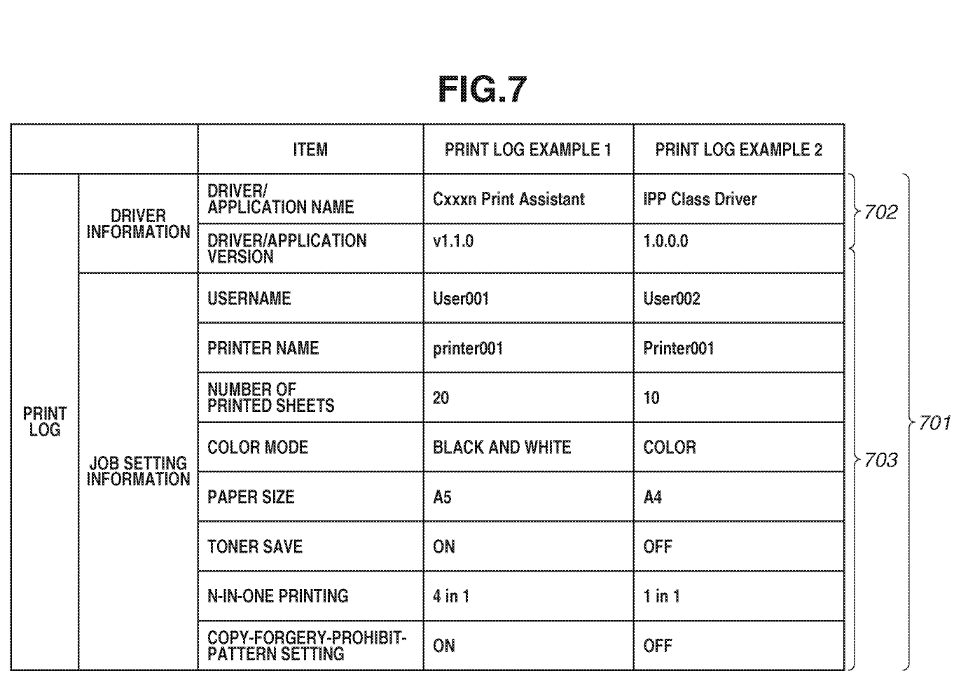

FIG. 7 illustrates an example of the print log information 701 transmitted from the image forming apparatus 102 to the print log server 103.

The print log information 701 is constituted by information such as the driver information 702 and the job setting information 703.

The driver information 702 includes information such as the name of the driver application and the driver version, which are the identification information for identifying the driver from which the print job is fed.

The job setting information 703 includes information such as the username, the printer name, and the number of printed sheets. In the job setting information 703, the information at the time of print job execution is set by referring to the IPP attribute information, and the print setting information of the image forming apparatus 102.

The print log information 701 does not necessarily have to include both the driver information 702 and the job setting information 703, and may be constituted by any one of the driver information 702 and the job setting information 703. Further, the print log information 701 may include only a part of the items in the driver information 702 or the job setting information 703, such as only the driver/application name or only the number of printed sheets.

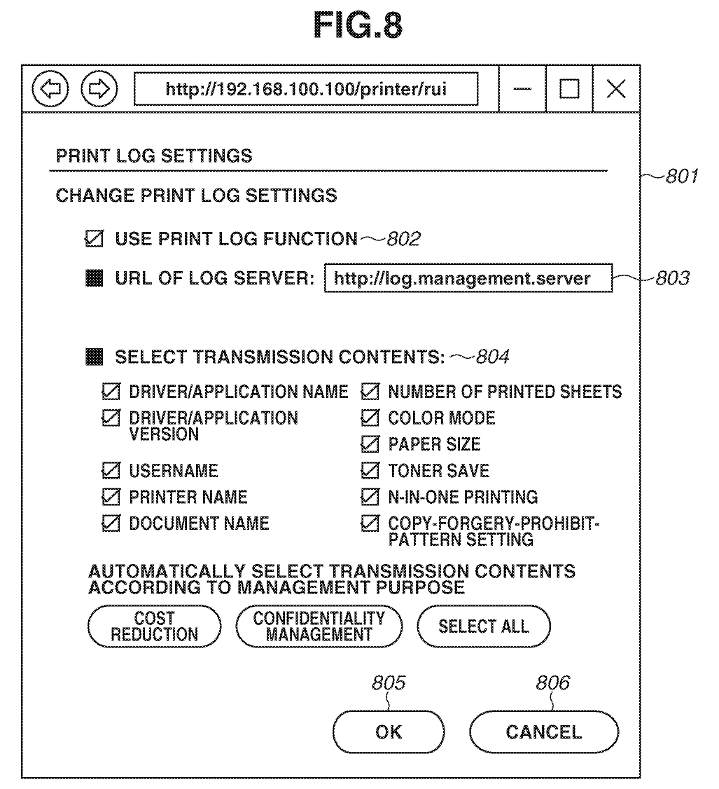

FIG. 8 illustrates an example of the remote UI screen when the print log settings are configured.

Now, the remote UI is a function that the image forming apparatus 102 has, and can display screen information generated by the image forming apparatus 102 on a Web browser of the information processing apparatus. The print log setting screen 801 may be displayed on the display unit 226 of the image forming apparatus 102.

The print log setting screen 801 includes a print log function enablement button 802, a print log server information input region 803, a transmission content selection region 804, an OK button 805, and a cancel button 806.

The user can set whether to enable or disable the print log function from the print log function enablement button 802. When the print log function is enabled, the image forming apparatus 102 receives an input of an item to be included as the print log information 701 from the user on the print log setting screen 801 and stores the print log setting information after the print processing (step S417). In step S418, the image forming apparatus 102 generates the print log information 701 based on this print log setting information.

After that, in step S419, the image forming apparatus 102 transmits the print log information 701 to the print log server 103. The process of receiving the input of an item to be included as the print log information 701 from the user on the print log setting screen 801 is an example of a log item reception process.

The user can set the URL, the port number, the communication method, and/or the like of the print log server 103 in the print log server information input region 803.

The user can select information to be transmitted as the print log information 701 in the transmission content selection region 804. The setting of the transmission information can be determined for each setting item.

Further, the print log setting screen 801 also allows transmission items suitable according to a purpose of the management and the analysis of the print log information 701, such as "cost reduction" or "confidentiality management", to be managed in association with the purpose, provides an object for selecting the purpose, and allows the user to collectively set these items all at once by pressing one button.

Now, the collective setting can be realized by storing array information associating the intended use of the print log information 701 and the transmission contents of the print log information 701 in the storage unit 224 of the image forming apparatus 102.

For example, associating the transmission contents such as the number of printed sheets, the color mode, the paper size, the toner save, and the N-in-one printing with the intended use "cost reduction" causes the image forming apparatus 102 to select and unselect these transmission contents associated with the selected intended use all at once.

When the OK button 805 is pressed, the image forming apparatus 102 stores the set print log setting information. On the other hand, when the cancel button 806 is pressed, the image forming apparatus 102 closes the print log setting screen 801 without storing the set print log setting information. The user who selects the settings on the print log setting screen 801 is mainly assumed to be an administrator user who uses the print log management application 314, but is not limited thereto. For example, a user who does not use the print log management application 314 but uses the image forming apparatus 102 may configure the print log settings under an office environment or the like.

Further, in the case where the development vendor of the print setting expansion application 312 collects the print log information 701, the print log setting screen 801 may be a screen where the user can set an item to be transmitted to the print log server 103 or an item not to be transmitted to the print log server 103. For example, the print log setting screen 801 may be configured in such a manner that, in a case where confidential information or the like is contained in a document name, the document name is not transmitted to the print log server 103 if the user unselects the document name in the transmission content selection region 804.

### Second Embodiment

A second embodiment will be described with respect to a flow until the usage is analyzed based on the print log using a print log collection system and a print log management application according to the present embodiment and a specific improvement idea is suggested from the print log management application to an administrator user.

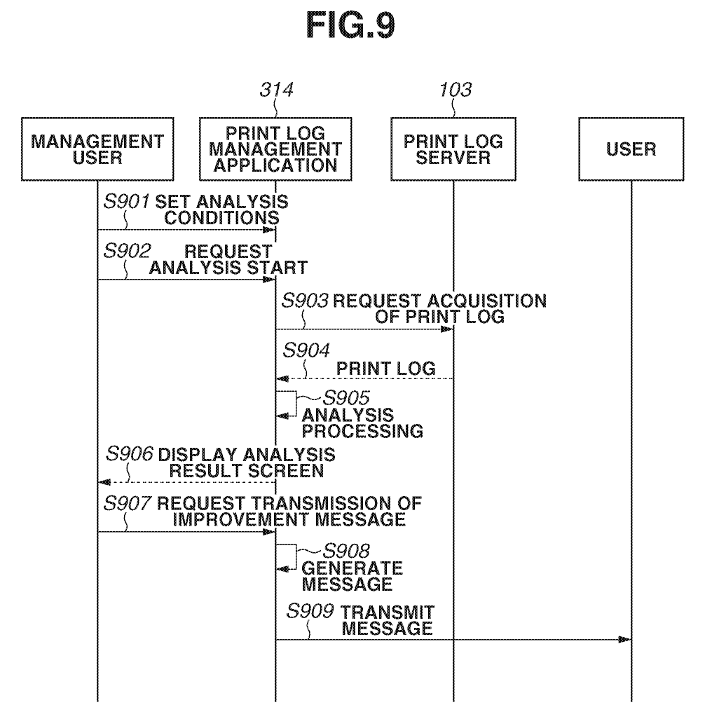

FIG. 9 is a sequence diagram illustrating an example of a series of processing procedures according to the present embodiment.

First, in step S901, the administrator user who analyzes the print log information 701 sets analysis conditions on the print log management application 314. In step S902, the administrator user issues an analysis start request to the print log management application 314. After the analysis start request is issued by the user, in step S903, the print log management application 314 requests acquisition of the print log information 701 to the print log server 103. The administrator user can operate the settings of the analysis conditions (step S901) and the analysis start request (step S902) on the print log management application 314 via, for example, an analysis start screen 1101 of the print log management application 314.

Further, when requesting the acquisition of the print log (step S903), the user can also request it so as to acquire only specific print log information by specifying a condition such as a time period or a device. The process in step S901 is an example of an analysis condition reception process.

Next, in step S904, after receiving the print log acquisition request, the print log server 103 extracts the corresponding print log information from the print log information 701 stored in the print log storage area 331, and transmits it to the print log management application 314. The timing of acquiring the print log information 701 may be any timing before the analysis is started.

Next, in step S905, the print log management application 314 analyzes the usage of the apparatus based on the received print log information 701. For example, when the "cost reduction" item is selected as the analysis conditions, the print log management application 314 makes the analysis with respect to items related to print cost, such as the toner save, the N-in-one printing, and the color mode in the acquired print log. For the analysis, a rule-based analysis or an analysis using artificial intelligence like generative AI may be used.

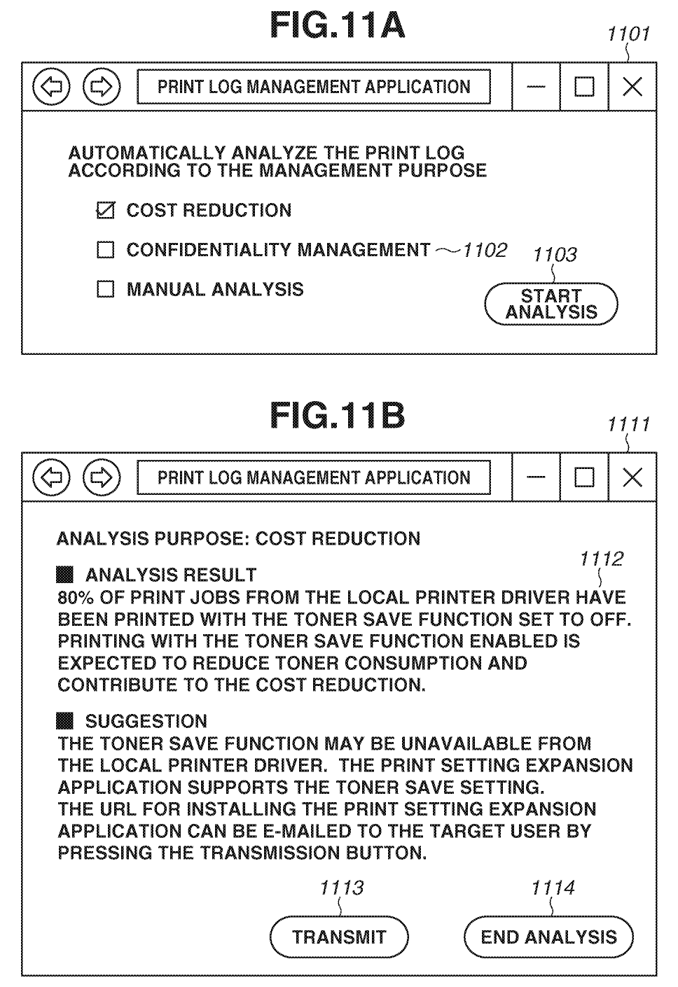

Next, after the print log management application 314 completes the print log analysis processing (step S905), in step S906, the print log management application 314 displays an analysis result screen. For example, the analysis result screen is a screen as illustrated in FIG. 11B, and is a screen containing contents such as an analysis result and suggestion of an improvement idea. The process in step S906 is an example of a display process.

In a case where the print job serving as a cause is fed via the local printer driver 311, advanced setting functions such as the toner save and the N-in-one printing may be unusable. In such a case, the print log management application 314 suggests, for example, an idea prompting a target user, who performs printing using the local printer driver 311, to use the print setting expansion application 312. More specifically, the print log management application 314 suggests, for example, e-mail transmission of a URL for installing the print setting expansion application 312 to prompt the target user to use the print setting expansion application 312 (step S907).

Now, suppose that the suggestion recommending the transmission of the URL for installing the print setting expansion application 312 is displayed like the analysis result screen 1111. If the administrator user presses an e-mail transmission button 1113 at this time, in step S908, the print log management application 314 performs message generation processing.

In the message generation processing (step S908), the print log management application 314, for example, selects the destination of transmission to the user to which the message is transmitted and acquires the URL for installing the print setting expansion application 312 from user information 1001 and device information 1002 managed by the print log management application 314. Now, the information stored as the user information 1001 is, for example, information about the user who uses the image forming apparatus 102, and, for example, an e-mail address of the user is stored therein.

After that, in step S909, the print log management application 314 transmits the message containing the URL for installing the print setting expansion application 312 to the e-mail address of the target user. This allows the user who uses the image forming apparatus 102 to configure the advanced setting by receiving the message and installing the print setting expansion application 312, thereby being expected to contribute to improving a problem emerging as a result of the analysis. In this manner, the administrator user can easily put into practice the improvement idea against the problem analyzed based on the print log information 701 by the print log management application 314.

The user who selects the settings on the print log setting screen 801 illustrated in FIG. 8 is mainly assumed to be the administrator user who uses the print log management application 314, but is not limited thereto. For example, a user who does not use the print log management application 314 but uses the image forming apparatus 102 may configure the print log settings under an office environment or the like.

Further, the administrator user who analyzes the print log information using the print log management application 314 is mainly assumed to be different from the user who uses the image forming apparatus 102, but is not limited thereto. For example, a user who uses the image forming apparatus 102 at home may use the print log management application 314 to confirm the usage of the image forming apparatus 102.

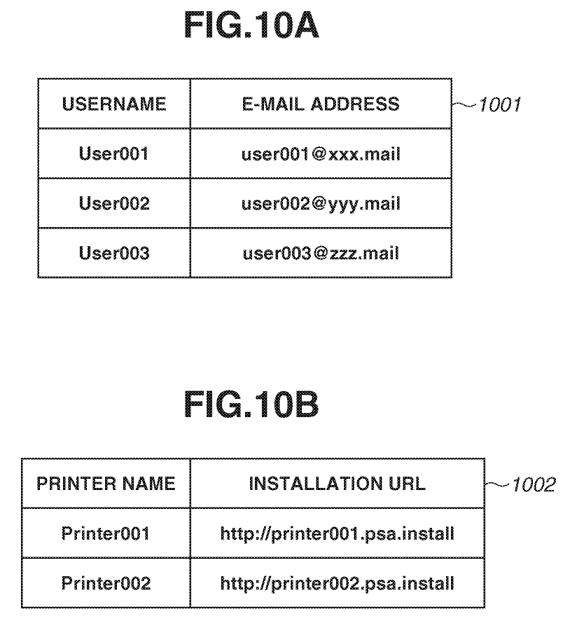

FIG. 10A and 10B illustrate examples of the user information 1001 and the device information 1002 managed by the print log management application 314, respectively.

The user information 1001 illustrated in FIG. 10A is information in which information usable to identify the user (for example, the username) and the message transmission destination (for example, the e-mail address) are associated with each other. The information indicating the message transmission destination, which is categorized into personal information, is often omitted in the print log information 701, and therefore is to be separately managed by the print log management application 314.

The device information 1002 illustrated in FIG. 10B is information in which information usable to identify the printer (for example, the printer name) and the URL for installing the print setting expansion application 312 are associated with each other.

The print log management application 314 may be configured not to manage the user information 1001 and the device information 1002, and acquire information managed by another server or the image forming apparatus 102 to utilize it.

FIGS. 11A and 11B illustrate examples of the analysis start screen 1101 and the analysis result screen 1111 of the print log management application 314, respectively.

The analysis start screen 1101 illustrated in FIG. 11A is constituted by elements such as an analysis condition setting region 1102 and an analysis start button 1103. Objects "cost reduction", "confidentiality management", and "manual analysis" in the analysis condition setting region 1102 are examples of an object that allows the user to determine the print log information 701 to use in the analysis. The user can perform the print log analysis processing (step S905) on the print log management application 314 by selecting the print conditions in the analysis condition setting region 1102 and pressing the analysis start button 1103 on the analysis start screen 1101.

The analysis result screen 1111 is constituted by elements such as an analysis result display region 1112, the transmission button 1113, and an analysis end button 1114. The user can confirm a result of the print log analysis processing (step S905) in the analysis result display region 1112 on the analysis result screen 1111. The user can close the analysis result screen 1111 by pressing the analysis end button 1114. The transmission button 1113 is an example of an object for prompting the user who uses the image forming apparatus 102 to install the print setting expansion application 312.

Further, when prompting the target user to install the print setting expansion application 312 as a solution in the print log analysis processing (step S905), the administrator user presses the transmission button 1113. By that, in step S908, the message generation processing is performed. Then, in step S909, the message is transmitted to the target user.

According to the present disclosure, the identifier indicating that the print instruction is issued using the print setting expansion application can be added to the print log information generated by the image forming apparatus.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-049639, which was filed on Mar. 25, 2025 and which is hereby incorporated by reference herein in its entirety.

What is claimed is:

1. A control method of an information processing apparatus that receives a print job from a client terminal, the information processing apparatus comprising at least one processor operating to perform the control method,
the client terminal including an Internet Printing Protocol (IPP) class driver and an application program installed based on identification information of the information processing apparatus,
the method comprising:
receiving information regarding the print job from the client terminal, the information including first information indicating that a print instruction is issued using the application program; and
adding second information based on the first information to print log information of the print job.

2. The control method according to claim 1, wherein the print log information is information regarding the print job that the information processing apparatus receives from the client terminal.

3. The control method according to claim 1, further comprising performing log item reception of receiving an input of an item to be included as the print log information generated by the information processing apparatus from a user,
wherein the control method includes the adding in a case where an item indicating whether the print instruction is issued using the application program is included in the item to be included as the print log information.

4. The control method according to claim 3, wherein the log item reception includes displaying an object that allows the user to determine the item to be included as the print log information according to a purpose for managing the print log information.

5. The control method according to claim 4, wherein the object is displayed on a remote user interface provided by the information processing apparatus.

6. The control method according to claim 1,
wherein the first information is information included in IPP attribute information transmitted from the client terminal to the information processing apparatus, and
wherein the IPP attribute information further includes a print setting for performing printing on the image forming apparatus, and the print log information includes job setting information generated based on the print setting.

7. The control method according to claim 6, wherein, in a case where the first information is not included in the IPP attribute information and a print setting unsettable by the IPP class driver is included in the print setting, the information processing apparatus determines that the print instruction is issued using the application program and performs control in such a manner that the second information is included in the print log information.

8. The control method according to claim 1, wherein the information processing apparatus includes a print unit that performs printing based on the print job.

9. A non-transitory computer-readable storage medium storing computer-executable instructions for causing a computer to perform a method comprising:
receiving information regarding a print job from a client terminal, the client terminal including an IPP class driver and an application program installed based on identification information of an information processing apparatus, the information including first information indicating that a print instruction is issued using the application program; and
adding second information based on the first information to print log information of the print job.

10. An information processing apparatus comprising:
at least one processor; and
at least one memory that is in communication with the at least one processor, wherein the at least one memory stores instructions for causing the at least one processor and the at least one memory to:
receive information regarding a print job from a client terminal, the client terminal including an IPP class driver and an application program installed based on identification information of the information processing apparatus, the information including first information indicating that a print instruction is issued using the application program; and
add second information based on the first information to print log information of the print job.
